(19) United States
(12) Patent Application Publication
(10) Pub. No.: US 2025/0341412 A1
(43) Pub. Date: Nov. 6, 2025

(54) MAGNETIC-INDUCTIVE FLOW MEASUREMENT DEVICE

(71) Applicant: Endress+Hauser Flowtec AG, Reinach (CH)

(72) Inventors: Florent Tschambser, Hesingue (FR); Tulio Paiva Galvao, Schopfheim (DE); Jean-Marc Baysang, Heimersdorf (FR); Beat Grüter, Arlesheim (CH)

(21) Appl. No.: 18/715,621

(22) PCT Filed: Nov. 22, 2022
(86) PCT No.: PCT/EP2022/082699

§ 371 Date: Nov. 1, 2024

(30) Foreign Application Priority Data
Dec. 1, 2021 (DE) 10 2021 131 698.7

(51) Int. Cl. G01F 1/60; G01F 1/58

(52) U.S. Cl. CPC G01F 1/60; G01F 1/586

(57) ABSTRACT

A magnetic-inductive flow measurement device includes: a device for generating a magnetic field, including a first coil and a second coil; a device for tapping a measurement voltage induced in a flowable medium; an operating circuit configured to apply a first operating signal to the first coil and separately a second operating signal to the second coil, wherein a first voltage over a first time subinterval is applied to the coils, and coil currents of different measurement intervals of the first operating signal are changeable variables; and a control circuit configured to control at least the first voltage of the first operating signal such that a deviation of a control function from a predefined control target value, which includes a variable proportional to a magnetic flux, is minimized.

The invention relates to a magnetic-inductive flow measurement device, in particular a magnetic-inductive flow meter and/or a magnetic-inductive flow measuring probe.

Magnetic-inductive flow measurement devices are used for determining the flow rate and the volumetric flow of a flowing medium in a pipeline. A distinction is made here between in-line magnetic-inductive flow meters and magnetic-inductive flow measuring probes, which are inserted into a lateral opening of a pipeline. A magnetic-inductive flow meter has a device for generating a magnetic field, which produces a magnetic field perpendicularly to the flow direction of the flowing medium. Single coils are typically used for this purpose. In order to realize a predominantly homogeneous magnetic field, pole shoes are additionally formed and attached such that the magnetic field lines run over the entire tube cross-section substantially perpendicularly to the transverse axis or in parallel to the vertical axis of the measuring tube. In addition, a magnetic-inductive flow meter has a measuring tube on which the device for generating the magnetic field is arranged. A measurement electrode pair attached to the lateral surface of the measuring tube taps an electrical measurement voltage or potential difference which is applied perpendicularly to the direction of flow and to the magnetic field and occurs when a conductive medium flows in the direction of flow when the magnetic field is applied. Since, according to Faraday's law of induction, the tapped measurement voltage depends on the velocity of the flowing medium, the flow rate and, with the inclusion of a known tube cross-section, the volumetric flow can be determined from the induced measurement voltage.

In contrast to a magnetic-inductive flow meter, which comprises a measuring tube for conducting the medium with an attached device for generating a magnetic field penetrating the measuring tube and with measuring electrodes, magnetic-inductive flow measuring probes are inserted with their usually circular cylindrical housings into a lateral opening of a tube line and fixed in a fluid-tight manner. A special measuring tube is no longer necessary. The measuring electrode arrangement and coil arrangement, mentioned in the introduction, on the lateral surface of the measuring tube are omitted and are replaced by a device for generating a magnetic field, which device is arranged in the interior of the housing and in direct proximity to the measuring electrodes and is designed such that an axis of symmetry of the magnetic field lines of the generated magnetic field perpendicularly intersects the front face or the face between the measuring electrodes. In the prior art, there is already a plurality of different magnetic-inductive flow measuring probes.

Magnetic-inductive flow measurement devices are often used in process and automation engineering for fluids, starting from an electrical conductivity of approximately 5 μS/cm. Corresponding flow measurement devices are sold by the applicant in a wide variety of embodiments for various fields of application, for example under the name PROMAG or MAGPHANT.

There is a plurality of different methods for controlling the operating signal applied to the coil arrangement. Generally, they aim at generating a magnetic field with a magnetic induction that is as constant as possible over an entire measurement phase. WO 14 2014/001026 A1, for example, discloses a controller in which an operating signal applied to the coil arrangement is controlled in such a way that a (coil) current flowing through the coil arrangement reaches and maintains a (coil) current target value in a defined measurement phase. The (coil) current flowing through the coil arrangement produces a magnetic field with a magnetic induction dependent on the (coil) current.

DE 10 2015 116 771 B4 also discloses a method for setting a constant magnetic field strength of a magnetic field in a magnetic-inductive flow meter, whereby a constant target current is predefined for a current controller.

It is basically assumed that by establishing a fixed (coil) current target value, the magnetic induction of the produced magnetic field also assumes a target value in a reproducible manner. An advantage of such a control is that the control does not require measuring the magnetic induction. However, it has been found that, due to temperature changes and magnetic interference fields, the magnetic induction cannot be reproduced solely by adjustment to a fixed (coil) current target value. As a result, the value assumed for determining the flow-rate-dependent measured variable for magnetic induction differs from the currently present magnetic induction in the measuring tube. Depending on the disturbance variable, this can lead to deviations of up to 20% when determining the flow-rate-dependent measured variable.

EP3211384A2 discloses a magnetic-inductive flow meter which has at least two pairs of coils arranged on the circumference of the measuring tube. The pairs of coils each have two coils connected in series, which are arranged offset to each other in the flow direction. Furthermore, a plurality of scenarios are disclosed as to how the pairs of coils can be energized separately.

The invention is based on the object of providing a magnetic-inductive flow measurement device with a more robust magnetic field.

The object is achieved by the magnetic-inductive flow measurement device according to claim 1.

The magnetic-inductive flow measurement device according to the invention for determining a flow-rate-dependent measured variable for a flowable medium, comprising:
a device for generating a magnetic field, comprising at least a first coil and a second coil;
a device for tapping off a measurement voltage induced in the flowable medium, in particular comprising at least two preferably diametrically arranged measurement electrodes;
an operating circuit which is configured to apply a first operating signal to the first coil and separately a second operating signal to the second coil,
wherein the first operating signal and the second operating signal each have a time-varying (coil) voltage curve which is divided into time intervals,
wherein the time intervals each have a first time subinterval in which a first (coil) voltage, which is preferably constant over the, in particular entire, first time subinterval, is applied to the coils,
wherein the time intervals of the first operating signal each have at least one measurement interval in which a (coil) current flows through the first coil,
wherein coil currents of different measurement intervals of the first operating signal are changeable variables; and
a control circuit,
wherein the control circuit is configured to control at least the first (coil) voltage of the first operating signal such that a deviation of a control function from a predefined control target value, in particular a control target value comprising a variable that is proportional to a magnetic flux, is minimal.

Separate operation of the two coils has the advantage that it is thus possible to react to aging of a single coil and, at the same time, to adapt the magnetic field to be generated to the corresponding flow profile in the medium. Furthermore, the operating signals can be adapted individually to thus react to external interference magnets.

Advantageous embodiment of the invention are the subject matter of the dependent claims.

One embodiment provides for the first operating signal and the second operating signal to be synchronized in such a way that the respective time intervals of the two operating signals start at the same time.

One embodiment provides for the time intervals of the first operating signal to each have a second time subinterval in which a second (coil) voltage, which is in particular constant, is applied to the first coil over the, in particular entire, second time subinterval,
wherein the second (coil) voltage is greater than the first (coil) voltage,
wherein the duration of the second time subinterval and the first (coil) voltage are each a changeable and controllable variable,
wherein the control function depends on a product of the duration of the second time subinterval and a function dependent on the first (coil) voltage.

Magnetic-inductive flow measurement devices with this type of control circuit are more resistant to external interference fields. The control circuit according to the invention is particularly advantageous for use in magnetic-inductive flow measurement devices supplied via an electrochemical storage unit. They are generally operated with a significantly lower current or a significantly lower (coil) voltage than conventional magnetic-inductive flow measurement devices that are supplied via a power supply. This means that the field-conducting components do not go into magnetic saturation during use. As a result, in addition to a particularly increased sensitivity to external interference fields, they also have an extended settling time during startup, wherein the settling time describes the period to be waited after the flow measurement device has been switched on until the device for generating the magnetic field is warmed up and in which the magnetic induction continuously settles toward the setpoint value. Magnetic-inductive flow measurement devices with the control circuit according to the invention moreover have a significantly lower temperature coefficient of the magnetic field, wherein the temperature coefficient describes the deviation of the magnetic field per temperature change.

The control target value determined and provided at the factory or during startup can be determined in an adjustment method or by computer simulation. The control target value further comprises a variable that is proportional to the magnetic flux. This means that the target value comprises the unit of one of the magnetic fluxes. The magnetic flux of a coil arrangement depends on the one hand on the self-induction L of the coil and a quadratic contribution of the (coil) current currently flowing through the coil arrangement, and on the other hand on the magnetic flux generated by eddy currents occurring in the metallic carrier tube and the housing. When attaching or bringing an external magnet closer to the magnetic-inductive flow measurement device, said magnet also contributes to the magnetic flux in the measuring tube.

One embodiment provides for the time intervals of the first operating signal and of the second operating signal to each have a second time subinterval in which a second (coil) voltage, which is in particular constant, is applied to the first coil over the, in particular entire, second time subinterval,
wherein the second (coil) voltage is greater than the first (coil) voltage,
wherein the duration of the second time subinterval and the first (coil) voltage are each a changeable and controllable variable,
wherein the control function depends on a product of the duration of the second time subinterval and a function dependent on the first (coil) voltage,
wherein the control circuit is configured to also control the first (coil) voltage of the second operating signal such that a deviation of a control function from a predefined control target value, in particular a control target value comprising a variable that is proportional to a magnetic flux, is minimal,
wherein coil currents of different measurement intervals of the second operating signal are changeable variables.

One embodiment provides for the duration of the first time subinterval of the first operating signal and the duration of the first time subinterval of the second operating signal to be the same in the respective time intervals.

One embodiment provides for a sum of the duration of the first time subinterval and the duration of the second time subinterval of the first operating signal and a sum of the duration of the first time subinterval and the duration of the second time subinterval of the second operating signal to be the same in the respective time intervals.

One embodiment provides for the first (coil) voltage of the first operating signal to differ from the first (coil) voltage of the second operating signal.

One embodiment provides for the second (coil) voltage of the first operating signal to differ from the second (coil) voltage of the second operating signal.

One embodiment provides for the control target value of the first operating signal to differ at least temporarily from the control target value of the second operating signal.
One embodiment provides for the control circuit to be configured to control the first (coil) voltage of the first operating signal and the first (coil) voltage of the second operating signal such that a deviation of a control function from a predefined control target value, in particular a control target value comprising a variable that is proportional to a magnetic flux, is minimal,
wherein the control target value depends on a product of the duration of the second time subinterval of the first operating signal and a function dependent on the first (coil) voltage of the first operating signal,
wherein the control target value also depends on a product of the duration of the second time subinterval of the second operating signal and a function dependent on the first (coil) voltage of the second operating signal.

Hence, the corresponding manipulated variables of all operating signals are controlled such that a control function valid for the entire coil arrangement does not deviate from the control target value.

One embodiment provides for the control circuit to be configured to control the first (coil) voltage of the second operating signal such that a deviation of the (coil) current during the measurement interval from a (coil) current target value, in particular a (coil) current target value predefined at the factory, is minimal.

It can be advantageous if the two operating signals have different controlled variables and/or manipulated variables.

One embodiment provides for the operating circuit to be configured to apply the first operating signal to the second coil for a duration of a diagnostic interval,
wherein a diagnostic circuit is configured to determine a corrected (coil) current target value as a function of the current flowing during the measurement interval of the first operating signal, which (coil) current target value replaces the predefined coil target value.

The advantage of this embodiment is that it enables recalibration of the (coil) current target value via the first operating signal and the second coil. The corrected (coil) current target value or the deviation of the corrected (coil) current target value from the factory-set (coil) current target value can be used for diagnostic purposes.

One embodiment provides for the device for generating the magnetic field to additionally comprise N further coils,

where N≥1,
wherein the operating circuit is also configured to operate the N further coils each with an operating signal,
wherein the operating signals for operating the N further coils each have a time-varying (coil) voltage curves that is divided into time intervals,
wherein the time intervals each have a first time subinterval in which a first (coil) voltage, which is preferably constant over the, in particular entire, first time subinterval, is applied to the N further coils,
wherein the time intervals of the operating signals each have a second time subinterval in which a second (coil) voltage, which is in particular constant, is applied to the N further coils over the, in particular entire, second time subinterval,
wherein the second (coil) voltage is greater than the first (coil) voltage,
wherein the duration of the second time subinterval and the first (coil) voltage are each a changeable and controllable variable,
wherein the control function depends on a product of the duration of the second time subinterval and a function dependent on the first (coil) voltage,
wherein the control circuit is also configured to control the first (coil) voltage of the N operating signals such that a deviation of a, in particular corresponding, control function from a predefined control target value, in particular a control target value comprising a variable that is proportional to a magnetic flux, is minimal.

The more coils there are, the more precisely a desired magnetic field can be resolved.

One embodiment provides for the control function to depend on at least three and preferably N+2 products of the duration of the second time subinterval and a function of the respective operating signals that is dependent on the first (coil) voltage.

One embodiment provides for the first operating signal to have rest intervals in which substantially no (coil) voltage is applied to the first coil, wherein a (coil) voltage is applied to the second coil during the rest intervals.

One embodiment provides for a diagnostic circuit to be configured to determine, as a function of a currently adjusted (coil) voltage value of the first (coil) voltage and/or a current duration of the second time subinterval, the coil that is disturbed by an external magnetic field.

Operating the coils separately allows for determining the position of a device generating a magnetic disturbance field relative to the magnetic-inductive flow measurement device. If a control function assigned to a single coil deviates more strongly or earlier from the control target value than the control functions of the other coils, the magnetic disturbance field generating device is located closer to the corresponding coil than to the other coils.

The invention is explained in greater detail with reference to the following figures. In the figures:

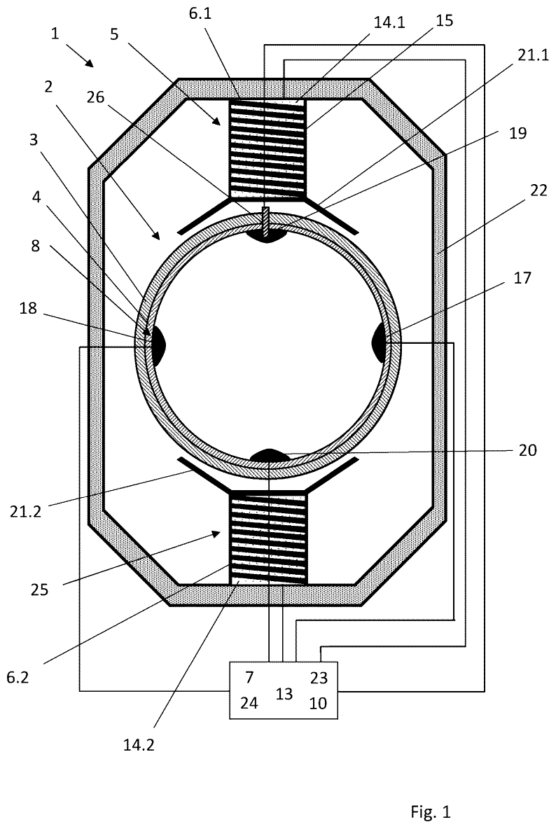

FIG. 1: shows an embodiment of a magnetic-inductive flow meter according to the invention;

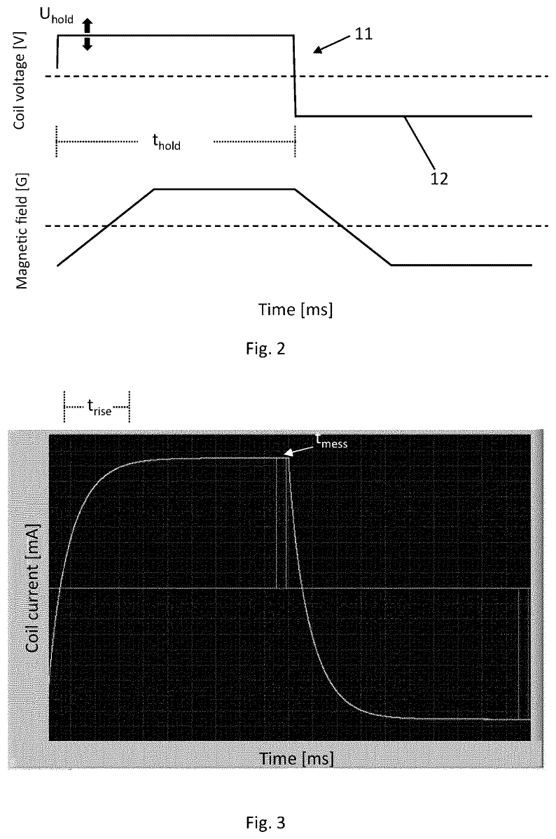

FIG. 2: shows a first embodiment of the curve of the (coil) voltage and the correspondingly produced magnetic field through the coil arrangement;

FIG. 3: shows a first embodiment of the curve of the current flowing through the coil arrangement;

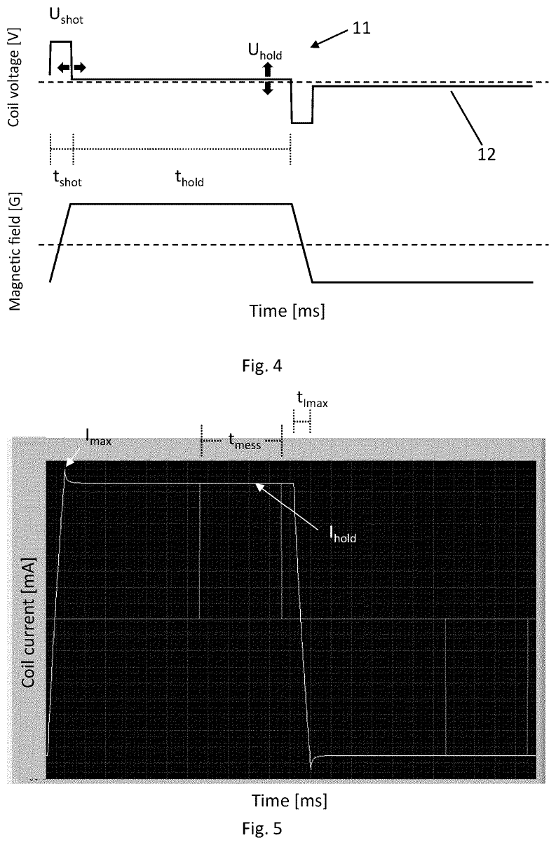

FIG. 4: shows a second embodiment of the curve of the (coil) voltage and the correspondingly produced magnetic field through the coil arrangement;

FIG. 5: shows a second embodiment of the curve of the (coil) voltage and the correspondingly produced magnetic field through the coil arrangement;

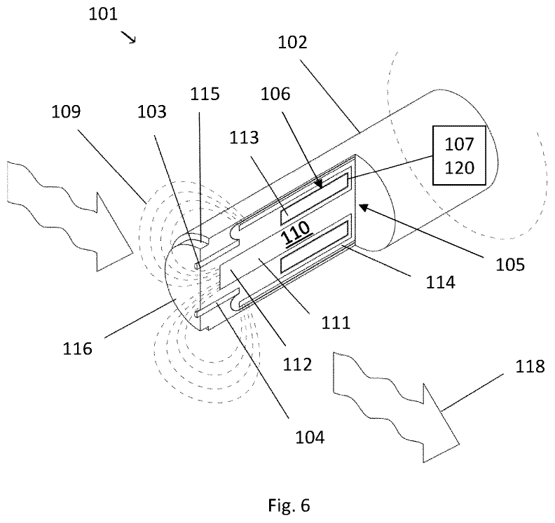

FIG. 6: shows a perspective view of a partially sectioned embodiment of a magnetic-inductive flow measuring probe according to the invention; and

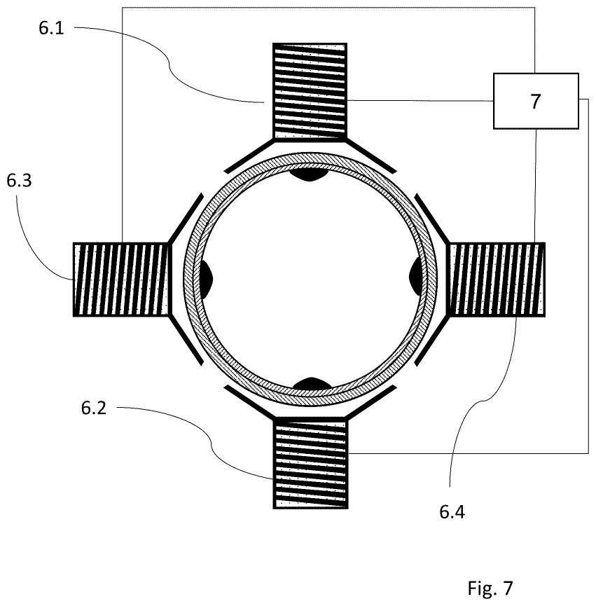

FIG. 7: shows another embodiment of a magnetic-inductive flow measurement device according to the invention.

FIG. 1 shows a cross-section of an embodiment of the magnetic-inductive flow meter 1 according to the invention. The structure and measuring principle of a magnetic-inductive flow meter 1 are known in principle. A flowable medium having an electrical conductivity is conducted through a measuring tube 2. The measuring tube 2 comprises a carrier tube 3, which is usually formed of, or at least comprises, steel, ceramic, plastic or glass. A device 5 for generating a magnetic field is arranged on the carrier tube 3 such that the magnetic field lines are oriented substantially perpendicularly to a longitudinal direction defined by the measuring tube axis. The device 5 for generating the magnetic field comprises a coil arrangement consisting of at least one saddle coil or at least one coil 6. Normally, magnetic-inductive flow meters have two diametrically arranged coils 6. A coil core 14 usually extends through a receptacle 15 of the coil 6.

The receptacle 15 is understood to mean the volume limited by the coil wire forming the coil 6. The receptacle 15 of the coil 6 can thus be formed by a coil holder or by the imaginary enclosed volume. The latter occurs when the coil wire of the coil 6 is wound directly around the coil core 14. The coil core 14 is formed from a magnetically conductive, in particular soft magnetic material. The device 5 for generating the magnetic field normally also comprises a pole shoe 21 which is arranged at one end of the coil core 14. The pole shoe 21 can be a separate component or can be monolithically connected to the coil core 14. In the embodiment shown in FIG. 1, two diametrically arranged coils 6.1, 6.2 each have a coil core 14.1, 14.2 and a pole shoe 21.1, 21.2. The two coil cores 14.1, 14.2 are connected to one another via a field return 22. The field return 22 connects the sides of the coil cores 14.1, 14.2 facing away from one another in each case. However, magnetic-inductive flow meters having exactly one coil having a coil core or a saddle coil and without a field return are also known. The device 5 for generating a magnetic field, in particular the coil 6 is connected to an operating circuit 7 which operates the coil 6 with an operating signal 11. The operating signal 11 can be a (coil) voltage with a time-varying voltage curve and is characterized by operating signal parameters, wherein at least one of the operating signal parameters is controllable. The magnetic field built up by the device 5 for generating the magnetic field is produced by a (coil) voltage of alternating polarity clocked by means of an operating circuit 7. This ensures a stable zero point and makes the measurement insensitive to influences due to electrochemical disturbances. The two coils 6.1, 6.2 are connected separately to the operating circuit 7.

When the magnetic field is applied, a flow-dependent potential distribution results in the measuring tube 2, which potential distribution can be detected, for example, in the form of an induced measurement voltage. A device 8 for tapping off the induced measurement voltage is arranged on the measuring tube 2. In the embodiment shown, the device 8 for tapping off the induced measurement voltage is formed by two oppositely arranged measurement electrodes 17, 18 to form a galvanic contact with the medium. However, what is also known are magnetic-inductive flow meters which comprise measurement electrodes arranged on the outer wall of the carrier tube 3 that are not in contact with a medium. The measurement electrodes 17, 18 are generally arranged diametrically and form an electrode axis or are intersected by a transverse axis which runs perpendicularly to the magnetic field lines and the longitudinal axis of the measuring tube 2. However, what is also known are devices 8 for tapping off the induced measurement voltage which have more than two measurement electrodes. The flow-rate-dependent measured variable can be determined on the basis of the measured measurement voltage. The flow-rate-dependent measured variable comprises the flow rate, the volume flow, and/or the mass flow of the medium. A measuring circuit 8 is configured to detect the induced measurement voltage applied to the measurement electrodes 17, 18, and an evaluation circuit 24 is designed to determine the flow-rate-dependent measured variable. Magnetic-inductive flow meters with temperature sensors 26 are known. They can be arranged in a lateral opening or integrated in one of the electrodes.

The carrier tube 3 is often formed from an electrically conductive material such as steel. In order to prevent the measurement voltage applied to the first and second measurement electrodes 2, 3 from being conducted away via the carrier tube 3, the inner wall is lined with an insulating material, for example a (plastic) liner 4.

Commercially available magnetic-inductive flow meters have two further electrodes 19, 20 in addition to measurement electrodes 17, 18. For one thing, a fill-level monitoring electrode 19 attached ideally at the highest point in the measuring tube 2 serves to detect partial filling of the measuring tube 1 and is configured to pass this information to the user and/or to take into account the fill level when determining the volume flow. Furthermore, a reference electrode 20, which is usually attached diametrically to the fill-level monitoring electrode 19 or at the lowest point of the measuring tube cross-section, serves to establish a controlled electric potential in the medium. Generally, the reference electrode 20 is used to connect the flowing medium to a ground potential.

The operating circuit 7, control circuit 10, measuring circuit 23, diagnostic circuit 13, and evaluation circuit 24 can be part of a single electronic circuit or can form individual circuits. At least the control circuit 10 has a microprocessor, in particular a programmable microprocessor, i.e., a processor designed as an integrated circuit, which is configured to adjust the voltages and the duration of the time subintervals and to change them so that the specification for the control function is fulfilled. The operating circuit 7 is further configured to feed electrical power into the first coil 6.1 by means of an electrical first operating signal, having a changeable (coil) voltage and a changeable (coil) current, and is also configured to feed electrical power into the second coil 6.2 by means of an electrical second operating signal having a changeable (coil) voltage and a changeable (coil) current. The first operating signal and the second operating signal each have a time-varying (coil) voltage curve, which is divided into time intervals (t), each with a first time subinterval in which a first (coil) voltage, which is in particular constant over the, in particular entire, first time subinterval t_{hold}, is applied to the coils 6.1, 6.2. A (coil) current flows through the first coil 6.1 at least during individual measurement intervals. The absolute values of the coil currents of different measurement intervals of the first operating signal are changeable variables. Alternatively, one of the two operating signals can be designed in such a way that the (coil) current during the measurement intervals always assumes a set (coil) current target value, in particular a factory-set value. This means that the controls of the two coils 6.1, 6.2 can also be different, i.e., they can have different controlled variables and/or manipulated variables.

The diagnostic circuit 13 is configured and suitable to determine, as a function of a currently adjusted (coil) voltage value of the first (coil) voltage and/or a current duration of the second time subinterval, the coil 6.1, 6.2 that is disturbed by an external magnetic field.

The operating circuit 7 is configured to apply a first (coil) voltage to the device 5 for generating the magnetic field for a first time subinterval. According to an advantageous embodiment, the time intervals also each have a second time subinterval in which a, in particular constant, second (coil) voltage second voltage is applied to the device 5 for generating the magnetic field over the, in particular entire, second time subinterval. The second (coil) voltage is greater than the first (coil) voltage. In addition, in a single time interval, the first time subinterval follows the second time subinterval. The duration of the first time subinterval is greater than the duration of the second time subinterval. The duration of the second time subinterval is a controllable variable. So is the first (coil) voltage. FIG. 2 to FIG. 5 show possible embodiments of the operating signal.

According to the invention, the control circuit 10 is configured to control one of the operating signal parameters of the operating signal, in particular at least the first (coil) voltage (U_{hold}), such that a deviation of a control function from a predefined control target value, in particular a control target value comprising a variable that is proportional to a magnetic flux, is minimal. The control function can depend on a product of the duration of the second time subinterval and a function dependent on the first (coil) voltage. For this purpose, the first (coil) voltage and the duration of the second time subinterval are controlled such that a variable dependent on the first (coil) voltage and on the duration of the second time subinterval does not deviate from the control target value. In case of a deviation, due to magnetic interference fields or temperature influences, the two control parameters are adjusted until the deviation of the product from the control target value is minimal again.

FIG. 2 shows a first embodiment of the first operating signal 11.1 and/or of the second operating signal 11.2 and the correspondingly produced magnetic field through the coil. The operating signals are not numbered hereinafter, as the basic principle of the operating signals is explained in FIG. 2 and also in FIG. 4. According to the invention, the operating signal 11 comprises a (coil) voltage with a time-varying curve 12 which is divided into time intervals t. The sign of the applied (coil) voltage changes in successive time intervals t. The operating signal 11 shown in FIG. 2 comprises time intervals t, each having a first time subinterval t_{hold} in which a constant first (coil) voltage U_{hold} is applied to the coil over the entire duration of the first time subinterval t_{hold}. The detected measurement voltage induced for determining the flow-rate-dependent measured variable is determined in the first time subinterval t_{hold}, in particular during a measurement interval. During the measurement interval, a (coil) current flows through the device 5 to generate the magnetic field. Said (coil) current is not controlled constantly, i.e., an absolute value of a (coil) current flowing during the measurement interval is a changeable variable at different time intervals t. According to the first embodiment, the control circuit 10 is configured to control the first (coil) voltage U_{hold} of a time interval t such that a deviation of a control function from a predefined control target value, in particular a control target value comprising a variable that is proportional to a magnetic flux, is minimal. According to the invention, the first (coil) voltage U_{hold} is a time-varying and controllable variable. The increase in the (coil) current is characterized by a duration of a time subinterval tᵣᵢₛₑ, which can be determined via a measuring circuit. An absolute value of the (coil) current increases from a first (coil) current target value to a second (coil) current target value during the time subinterval tᵣᵢₛₑ. The first (coil) voltage U_{hold} is controlled such that a variable dependent on the product of the duration of the time subinterval tᵣᵢₛₑ and the first (coil) voltage U_{hold} does not deviate from a predefined second target value.

FIG. 3 shows a time curve of the (coil) current resulting from the operating signal of FIG. 2. The direction of the (coil) current changes after switching the applied (coil) voltage. The absolute value of the (coil) current increases with a non-linear behavior within a rise time subinterval tᵣᵢₛₑ. The (coil) current approaches a maximum (coil) current value Iₘₐₓ. The measurement interval tₘₑₛₛ begins when the (coil) current is at its maximum and substantially no longer changes. Only measurement voltages that are determined in this time interval are included in the determination of the flow-rate-dependent variable.

FIG. 4 shows a second embodiment of the first operating signal 11.1 and/or of the second operating signal 11.2 and the produced magnetic field through the device for generating the magnetic field. According to the invention, the operating signal 11 comprises a (coil) voltage with a time-varying curve 12 which is divided into time intervals t. The sign of the applied (coil) voltage changes in successive time intervals t. The operating signal shown in FIG. 4 comprises time intervals t, each having a first time subinterval t_{hold} in which a constant first (coil) voltage U_{hold} is applied to the coil over the entire duration of the first time subinterval t_{hold}. The detected measurement voltage induced for determining the flow-rate-dependent measured variable is determined in the first time subinterval t_{hold}. In addition, the time intervals t each have a second time subinterval tₛₕₒₜ in which a second (coil) voltage Uₛₕₒₜ that is, in particular, constant over the entire duration of the second time subinterval tₛₕₒₜ is applied to the coil. The second (coil) voltage Uₛₕₒₜ is greater than the first (coil) voltage U_{hold}. The first time subinterval t_{hold} follows the second time subinterval tₛₕₒₜ in the voltage curve. In addition, the duration of the second time subinterval tₛₕₒₜ is less than the duration of the first time subinterval t_{hold}. The duration of the second time subinterval tₛₕₒₜ is time-varying and controllable. The same applies to the first (coil) voltage U_{hold}. At least the first (coil) voltage U_{hold} is controlled such that a deviation of a control function from a predefined control target value, in particular a control target value comprising a variable that is proportional to a magnetic flux, is minimal. The control function depends on a product of the duration of the second time subinterval tₛₕₒₜ and a function dependent on the first (coil) voltage U_{hold}. The control target value can be predefined for the entire voltage curve and hence for all time intervals. Alternatively, time intervals with a positive sign in the voltage curve can have a first control target value, and time intervals with a negative sign can have a second control target value, wherein the first control target value differs from the second control target value. Alternatively, one of the two operating signals can also be based on constant (coil) current control. This means that, for example, the first voltage is controlled such that during a measurement interval the deviation of the (coil) current from a (coil) current target value is minimal and is preferably zero.

The first (coil) voltage U_{hold} and the second (coil) voltage Uₛₕₒₜ can be defined such that a ratio between the first (coil) voltage U_{hold} and the second (coil) voltage Uₛₕₒₜ IS constant over the entire voltage curve 12, or that an absolute value of a quotient of the first (coil) voltage U_{hold} and second (coil) voltage Uₛₕₒₜ is constant over the voltage curve 12. This means that when controlling the first (coil) voltage U_{hold}, the second (coil) voltage Uₛₕₒₜ is also automatically adjusted proportional to change. In this case, the function dependent on the first (coil) voltage U_{hold} is preferably inversely proportional to the duration of the second time subinterval tₛₕₒₜ. Alternatively, the second (coil) voltage Uₛₕₒₜ, or an absolute value of the second (coil) voltage Uₛₕₒₜ, can assume a constant value over the entire voltage curve 12.

In addition to controlling the first (coil) voltage U_{hold}, the duration of the second time subinterval tₛₕₒₜ is controlled such that a determined value of a variable dependent on a test variable assumes a test target value within the duration of the second time subinterval tₛₕₒₜ. An example of such an implementation is disclosed in WO 2014/001026 A1. The variable can be, for example, a (coil) current target value, a sum or an integral of the measured values of the test variable for a predefined time segment. The two control parameters are controlled such that a function dependent on the product of the first (coil) voltage U_{hold} and the duration of the second time subinterval tₛₕₒₜ does not deviate from a predefined second control target value. The function dependent on the first (coil) voltage U_{hold} is inversely proportional to the duration of the second time subinterval tₛₕₒₜ. The test variable may be a measured value of the (coil) current, a time curve of a (coil) current, and/or a variable dependent thereon.

The control circuit is configured to, if a coil test current value or a test variable dependent on the coil test current value differs from a target value in a time interval ty, change the duration of the second time subinterval tₛₕₒₜ such that the difference is smaller in a temporally subsequent time interval t_{N+M}, where M≥1. The control circuit is also configured to, if the actual value differs from a target value in a time interval ty, change the first (coil) voltage U_{hold} such that the deviation from a target value is smaller in a temporally subsequent time interval t_{N+M}, where M≥1. However, at least one of the conditions listed above must be met. The controller circuit can be configured to control further variables and/or functions.

The control function, in particular the function dependent on the first (coil) voltage U_{hold}, can also depend on In ((Uₛₕₒₜ+U_{hold})/(Uₛₕₒₜ-U_{hold})) or be proportional thereto.

FIG. 5 shows a time curve of the (coil) current through the device for generating the magnetic field, in particular through the coil arrangement, resulting from the voltage signal in FIG. 4. The (coil) current changes the direction of flow in the individual time intervals. By applying the second coil voltage, which is many times higher than the first (coil) voltage, the (coil) current increases rapidly. From the start of the first time subinterval, the (coil) current continues to increase until it reaches the maximum (coil) current value Iₘₐₓ. The eddy currents are substantially constant in this time subinterval. The (coil) current then decreases and converges towards a substantially constant (coil) current value I_{hold}.

According to a further embodiment, a measuring circuit is configured to determine a maximum (coil) current value Iₘₐₓ in the first time subinterval t_{hold} and to control the duration of the second time subinterval tₛₕₒₜ and the function dependent on the first (coil) voltage U_{hold} such that a control function does not deviate from a predefined second target value, wherein the control function depends on a product of the duration of the second time subinterval tₛₕₒₜ and the function dependent on the first (coil) voltage U_{hold} and the maximum (coil) current value Iₘₐₓ.

Alternatively, the control circuit can be configured to control at least one of the operating signal parameters-preferably the first (coil) voltage U_{hold}-such that a function dependent of a quotient of the maximum (coil) current value Iₘₐₓ and a (coil) current value I_{hold} determined during the first time subinterval t_{hold} is constant over the operating signal.

According to one embodiment, the control function can depend on a product of the duration of a third time subinterval t_{Imax} and a function dependent on the first (coil) voltage U_{hold}. The third time subinterval t_{Imax} is limited by a start of the second time subinterval tₛₕₒₜ and a point in time at which the (coil) current assumes the maximum (coil) current value Iₘₐₓ.

The curves shown in FIG. 2 to FIG. 5 are highly simplified schemes. The magnetic field settles generally after the second time subinterval.

First, the measuring principle on which the invention is based is explained on the basis of the perspective and partially sectional illustration of FIG. 6. A flow measuring probe 101 comprises a generally circular cylindrical housing 102 having a predefined outer diameter. Said housing is adapted to the diameter of a bore, which is located in a wall of a tube line (not shown in FIG. 6) into which the flow measuring probe 101 is inserted in a fluid-tight manner. A medium to be measured flows in the tube line, and the flow measuring probe 101 is immersed into said medium practically perpendicularly to the flow direction of the medium, which is indicated by the wavy arrows 118. A front end 116 of the housing 102 that projects into the medium is sealed in a fluid-tight manner with a front body 115 made of insulating material. By means of a coil arrangement 106 arranged in the housing 102, a magnetic field 109 that extends through the end portion into the medium can be produced. A coil core 111, which at least partially consists of a soft magnetic material and is arranged in the housing 102, terminates at or near the end portion 116. A field return body 114 that surrounds the coil arrangement 106 and the coil core 111 is configured to return, into the housing 102, the magnetic field 109 extending through from the end portion. The coil core 111, the pole shoe 112 and the field return body 114 are each field-conducting bodies 110, which together form a field-conducting arrangement 105. A first and a second measurement electrodes 103, 104 forming a galvanic contact with the medium to be conducted form the device for detecting a measurement voltage induced in the medium and are arranged in the front body 115 and, like the outer walls of the housing, touch the medium. An electrical (coil) voltage induced due to Faraday's law of induction can be tapped off at the measurement electrodes 103, 104 by means of a measurement and/or evaluation unit. It is at a maximum if the flow measuring probe 101 is installed in the tube line such that a plane spanned by a straight line intersecting the two measurement electrodes 103, 104 and by a longitudinal axis of the flow measuring probe runs perpendicularly to the flow direction 118 or to the longitudinal axis of the tube line. An operating circuit 107 is electrically connected to the coil arrangement 106, in particular to the coil 113, and is configured to impress a clocked operating signal to the coil 113 in order to thus produce a clocked magnetic field 109. The control circuit 120 is configured to control at least one of the operating signal parameters of the operating signal, in particular the first (coil) voltage and preferably also the duration of the second time subinterval, such that a deviation of a control function from a predefined control target value, in particular a control target value comprising a variable that is proportional to a magnetic flux, is minimal. For this purpose, according to an advantageous embodiment, the function dependent on the first (coil) voltage U_{hold} and the duration of the second time subinterval tₛₕₒₜ are controlled such that both are inversely proportional to each other.

FIG. 7 shows a further embodiment of a magnetic-inductive flow measurement device according to the invention in the form of a magnetic-inductive flow meter. In addition to the first coil 6.1 and the second coil 6.2 arranged diametrically thereto, the magnetic-inductive flow meter has N further coils. The following applies to the embodiment shown: N=2. The third coil 6.3 and the fourth coil 6.4 are also attached to the outer circumference of the measuring tube. They are arranged diametrically to each other. The four coils differ neither in terms of the material of the single coil components nor in terms of the number of coil windings. Alternatively, it is also possible to use N+2 coils which differ in terms of the number of windings and in terms of material. The four coils shown are all electrically connected to operating circuit 7 and are operated separately by means of an operating signal. The operating signals for operating the N further coils each have a time-varying (coil) voltage curves, which is divided into time intervals, each with a first time subinterval in which a first (coil) voltage, which is in particular constant over the, in particular entire, first time subinterval is applied to the N further coils. Furthermore, the time intervals of the operating signals each have a second time subinterval in which a second (coil) voltage, which is in particular constant, is applied to the N further coils over the, in particular entire, second time subinterval. As regards the control, the control function depends on a product of the duration of the second time subinterval and a function dependent on the first (coil) voltage, in particular the first (coil) voltage. The control circuit is also configured to control the first (coil) voltage of the N operating signals such that a deviation of a, in particular corresponding, control function from a predefined control target value, in particular a control target value comprising a variable that is proportional to a magnetic flux, is minimal. Alternatively, the control function can depend on at least three and preferably N+2 products- or in this case on the four products—of the duration of the second time subinterval and a function of the respective operating signals that is dependent on the first (coil) voltage (U_{hold}).

1-16. (canceled)

17. A magnetic-inductive flow measurement device for determining a flow rate-dependent measured variable for a flowable medium, the magnetic-inductive flow measurement device comprising:
a device configured to generate a magnetic field, including a first coil and a second coil;
a device for tapping a measurement voltage induced in the flowable medium, including at least two diametrically arranged measurement electrodes;
an operating circuit configured to supply electrical power to:
the first coil via an electrical first operating signal having a changeable voltage and a changeable current; and
the second coil via an electrical second operating signal having a changeable voltage and a changeable current,
wherein the first operating signal and the second operating signal each have a time-varying voltage curve, which is divided into time intervals,
wherein the time intervals each include a first time subinterval in which a first coil voltage, which is constant over the entire first time subinterval, is applied to the first and second coils,
wherein the time intervals of the first operating signal each have at least one measurement interval in which a current flows through the first coil,
wherein coil currents of different measurement intervals of the first operating signal are changeable variables; and
a control circuit configured to control at least the first coil voltage of the first operating signal such that a deviation of a control function from a predefined control target value is minimized, wherein the control target value includes a variable that is proportional to a magnetic flux.

18. The magnetic-inductive flow measurement device according to claim 17, wherein the first operating signal and the second operating signal are synchronized such that the respective time intervals of first and second operating signals start simultaneously.

19. The magnetic-inductive flow measurement device according to claim 17, wherein:
the time intervals of the first operating signal each include a second time subinterval during which a constant second coil voltage is applied to the first coil over the entire second time subinterval;
the second coil voltage is greater than the first coil voltage;
a duration of the second time subinterval and the first voltage are each a changeable and controllable variable; and
the control function depends on a product of the duration of the second time subinterval and a function dependent on the first coil voltage.

20. The magnetic-inductive flow measurement device according to claim 17, wherein:
the time intervals of the first operating signal and of the second operating signal each include a second time subinterval during which a constant second coil voltage is applied to the first coil over the entire second time subinterval;
the second coil voltage is greater than the first coil voltage;
a duration of the second time subinterval and the first coil voltage are each a changeable and controllable variable;
the control function depends on a product of the duration of the second time subinterval and a function dependent on the first coil voltage;
the control circuit is configured to further control the first coil voltage of the second operating signal such that a deviation of the control function from a predefined control target value is minimized, wherein the control target value includes a variable that is proportional to a magnetic flux; and
coil currents of different measurement intervals of the second operating signal are changeable variables.

21. The magnetic-inductive flow measurement device according to claim 17, wherein a duration of the first time subinterval of the first operating signal and a duration of the first time subinterval of the second operating signal are the same in the respective time intervals.

22. The magnetic-inductive flow measurement device according to claim 17, wherein the time intervals of the first operating signal and of the second operating signal each include a second time subinterval during which a constant second coil voltage is applied to the first coil over the entire second time subinterval, and
wherein a sum of a duration of the first time subinterval and a duration of the second time subinterval of the first operating signal and a sum of a duration of the first time subinterval and a duration of the second time subinterval of the second operating signal are the same in the respective time intervals.

23. The magnetic-inductive flow measurement device according to claim 17, wherein the first coil voltage of the first operating signal differs from the first coil voltage of the second operating signal.

24. The magnetic-inductive flow measurement device according to claim 20, wherein the second coil voltage of the first operating signal differs from the second coil voltage of the second operating signal.

25. The magnetic-inductive flow measurement device according to claim 20, wherein the control target value of the first operating signal differs at least temporarily from the control target value of the second operating signal.

26. The magnetic-inductive flow measurement device according to claim 20, wherein the control circuit is configured to control the first coil voltage of the first operating signal and the first coil voltage of the second operating signal such that a deviation of the control function from the predefined control target value, which includes a variable that is proportional to a magnetic flux, is minimized,
wherein the control target value depends on a product of the duration of the second time subinterval of the first operating signal and a function dependent on the first coil voltage of the first operating signal,
wherein the control target value also depends on a product of the duration of the second time subinterval of the second operating signal and a function dependent on the first coil voltage of the second operating signal.

27. The magnetic-inductive flow measurement device according to claim 17, wherein the control circuit is configured to control the first coil voltage of the second operating signal such that a deviation of the coil current during the measurement interval from a coil current target value, which is predefined upon manufacture of the magnetic-inductive flow measurement device, is minimized.

28. The magnetic-inductive flow measurement device according to claim 27, wherein the operating circuit is configured to apply the first operating signal to the second coil for a duration of a diagnostic interval,
wherein a diagnostic circuit is configured to determine a corrected coil current target value as a function of the current flowing during the measurement interval of the first operating signal, which coil current target value replaces the predefined coil target value.

29. The magnetic-inductive flow measurement device according to claim 17, wherein:
the device for generating the magnetic field further comprises N further coils, where N≥3;
the operating circuit is further configured to operate the N further coils, each via an operating signal;
the operating signals of the N further coils each have a time-varying coil voltage curve that is divided into time intervals;
the time intervals each include a first time subinterval in which a first coil voltage, which is constant over the entire first time subinterval, is applied to the N further coils;
the time intervals of the operating signals each have a second time subinterval in which a second coil voltage, which is constant, is applied to the N further coils over the entire second time subinterval;
the second coil voltage is greater than the first coil voltage;
a duration of the second time subinterval and the first coil voltage are each a changeable and controllable variable;
the control function depends on a product of the duration of the second time subinterval and a function dependent on the first coil voltage; and
the control circuit is further configured to control the first coil voltage of the N operating signals such that a deviation of a corresponding control function from a predefined control target value, which includes a variable that is proportional to a magnetic flux, is minimized.

30. The magnetic-inductive flow measurement device according to claim 29, wherein the control function depends on at least three products of the duration of the second time subinterval and a function of the respective operating signals dependent on the first coil voltage.

31. The magnetic-inductive flow measurement device according to claim 30, wherein the control function depends on N+2 products of the duration of the second time subinterval and the function of the respective operating signals dependent on the first coil voltage.

32. The magnetic-inductive flow measurement device according to claim 17, wherein the first operating signal includes rest intervals in which substantially no voltage is applied to the first coil, wherein a coil voltage is applied to the second coil during the rest intervals.

33. The magnetic-inductive flow measurement device according to claim 17, wherein a diagnostic circuit is configured to determine which of the first and second coils is disturbed by an external magnetic field as a function of a presently adjusted coil voltage value of the first coil voltage and/or a current duration of the second time subinterval.
